(19) United States
(12) Patent Application Publication
(10) Pub. No.: US 2026/0323208 A1
(43) Pub. Date: Oct. 15, 2026

(54) ACOUSTIC SYSTEMS WITH SHARED ACOUSTIC CHANNELS AND SHARED SOUND PORTS

(71) Applicants: Sahil GUPTA, Montreal (CA); Soundskrit Inc., Montreal (CA)

(72) Inventors: Sahil Gupta, Montreal (CA); Ravi Patel, Montreal (CA); Mohamed Tarek Aly, Montreal (CA); Stephane Leahy, Montreal (CA)

(21) Appl. No.: 19/484,788

(22) PCT Filed: May 16, 2024
(86) PCT No.: PCT/US2024/029796

§ 371 Date: Nov. 14, 2025

Related U.S. Application Data
(60) Provisional application No. 63/467,205, filed on May 17, 2023.

(51) Int. Cl. H04R 1/40; H04R 1/08; H04R 3/00

(52) U.S. Cl. CPC H04R 1/406; H04R 1/08; H04R 3/005; H04R 2201/003; H04R 2201/403

(57) ABSTRACT

An acoustic system includes a plurality of acoustic sensor devices, including at least a first acoustic sensor device and a second acoustic sensor device. The acoustic system also includes a plurality of acoustic channels, including at least a first acoustic channel configured to provide a first coupling, the first coupling being between the first acoustic sensor device and an ambient medium, and a second acoustic channel configured to provide a second coupling, the second coupling being between the second acoustic sensor device and the ambient medium. The first acoustic channel and the second acoustic channel may include a shared channel portion that includes at least a portion of the first acoustic channel that is common with at least a portion of the second acoustic channel.

### CROSS-REFERENCES TO RELATED APPLICATIONS

This application claims the benefit of U.S. provisional application entitled “Acoustic Systems with Shared Acoustic Channels and Shared Sound Ports,” filed May 17, 2023, and assigned Ser. No. 63/467,205, the entire disclosure of which is hereby expressly incorporated by reference.

### BACKGROUND OF THE DISCLOSURE

### Field of the Disclosure

The disclosure relates generally to acoustic sensor devices, such as microphones.

### Brief Description of Related Technology

Omnidirectional acoustic sensor devices (e.g., omnidirectional microphones) measure the pressure of incoming sound. A transducer, or membrane, that moves in response to the incoming sound is encapsulated in a package. The transducer partitions the package into two air volumes, a front volume and back volume. The microphone package has a sound port that couples one of the volumes of air to the outside ambient environment (e.g., ambient air). As sound hits the microphone, the sound couples into one of the air volumes through the sound port and changes the pressure. This creates a difference in pressure between the front volume and back volume that creates a force on the transducer and drives its motion. In this configuration, the omnidirectional microphone responds equally to sound travelling at all directions.

Directional acoustic sensor devices (e.g., directional microphones) use two sound ports, exposing each opposing side of the transducer to the ambient environment. They are designed to have high sensitivity to sound travelling in one direction and low sensitivity to sound travelling in another direction. Directionality allows the microphone to separate sound sources.

Directional microphones respond to the difference in pressure between the two sound ports as sound waves travel in the ambient environment. A transducer, or membrane, is disposed in a package such that the transducer or membrane partitions the package into two air volumes, a front volume and a back volume. A first sound port formed in the package couples the front volume of air to the outside ambient environment at a first location. A second sound port formed in the package couples the back volume of air to the outside ambient environment at a second location spaced at some distance from the first location. As a sound wave travels past the microphone, the sound wave creates a first local pressure at the location of the first sound port and a second local pressure at the location of the second sound port. The difference in the first pressure and second pressure exerts a force on the membrane and cause the membrane to vibrate. The vibrations of the membrane are then converted to an electrical signal through one of a variety of transduction mechanism such as capacitive, piezoelectric, optical, or piezoresistive readout.

In some systems, multiple acoustic sensor devices, such as multiple microphones, are used to sense the surrounding ambient environment. Such multi-microphone systems may be configured to process outputs of the multiple microphones, for example to determine directions from where different sounds originate in the ambient environment, and amplify sound that originates from a certain direction while cancelling out or deemphasizing sounds that originate from other directions. A typical multi-microphone system includes multiple acoustic channels and multiple sound ports that couple respective transducers of the microphones to the ambient environment. Thus, for example, a typical system that includes an omnidirectional microphone and a directional microphone requires an acoustic channel and a sound port to couple a transducer of the omnidirectional microphone to the ambient environment and a separate set of two acoustic channels and two sound ports that couple respective sides of a transducer of the directional microphone to the ambient environment.

Thus, such typical microphone systems generally require three separate acoustic channels and three separate sound ports. As another example, a typical system that includes two directional microphones requires a set of two acoustic channels and two sound ports to couple respective sides of a transducer of the first directional microphone to the ambient environment and a separate set of two acoustic channels and two sound ports that couple two sides of a transducer of the second directional microphone to the ambient environment. In this example, the typical microphone system generally requires four separate acoustic channels and four separate sound ports.

Systems with greater numbers of microphones, such as three microphones, generally require proportionally greater numbers of acoustic channels and sound ports. The separate acoustic channels and separate sound ports used for the respective microphones in such systems generally result in an increased size of the microphone system. Further, when such multi-microphone systems are integrated into an end-point device, a greater number of sound ports needs to be provided in the end-product device. Oftentimes, a greater number of sound ports in an end-point device is considered undesirable from an industrial design perspective. Thus, although multi-microphone system may provide greater directionality and sound quality, these performance improvements come at the cost of increased area and increased packaging constraints that sometimes limit the usability of the multi-microphone systems.

### SUMMARY OF THE DISCLOSURE

In accordance with an aspect, an acoustic system includes a plurality of acoustic sensor devices, including at least a first acoustic sensor device and a second acoustic sensor device. The acoustic system also includes a plurality of acoustic channels, including at least a first acoustic channel configured to provide a first coupling, the first coupling being between the first acoustic sensor device and an ambient medium, and a second acoustic channel configured to provide a second coupling, the second coupling being between the second acoustic sensor device and the ambient medium. The first acoustic channel and the second acoustic channel may include a shared channel portion that includes at least a portion of the first acoustic channel that is common with at least a portion of the second acoustic channel.

In connection with any one of the aforementioned aspects, the acoustic system may alternatively or additionally include or involve any suitable combination of one or more of the following aspects or features. The acoustic system may further include a shared sound port coupled, via the shared channel portion, to the first acoustic channel and the second acoustic channel. The first acoustic sensor device and the second acoustic sensor device are arranged on the acoustic system to have directions of sensitivity that are orthogonal with respect to each other. The acoustic system may further include a third acoustic sensor device and a third acoustic channel configured to provide a third coupling, the third coupling being between the third acoustic sensor device and the ambient medium. At least a portion of the third acoustic channel is in common with respective one or more portions of one or both of the first acoustic channel and the second acoustic channel. The shared channel portion includes the at least the portion of the first acoustic channel, the at least the portion of the second acoustic channel, and the at least the portion of the third acoustic channel. The acoustic system may further include a shared sound port coupled, via the shared channel portion, to the first acoustic channel, the second acoustic channel, and the third acoustic channel. The acoustic system may further include a plurality of shared sound ports, including at least i) a first shared sound port coupled to the first acoustic channel and the second acoustic channel and ii) a second shared port coupled to the third acoustic channel and one of the first acoustic channel and the second acoustic channel. Each of the first acoustic channel and the second acoustic channel may comprise a straight shaped channel. At least one the first acoustic channel and the second acoustic channel may comprise a non-straight shaped channel. The non-straight shaped channel may include one or more of a V-shaped channel, a U-shaped channel, or an L-shaped channel. The plurality of acoustic sensor devices includes a plurality of directional microphones. The plurality of acoustic sensor devices includes at least one directional acoustic sensor device and at least one ominidirectional microphone.

The plurality of acoustic sensor devices includes at least one microelectromechanical system (MEMS) microphone. The plurality of acoustic sensor devices includes a plurality of microelectromechanical system (MEMS) microphones.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a block diagram depicting an example acoustic sensing environment that includes an acoustic system with shared acoustic channels and/or shared sound ports, in accordance with an example.

FIG. 2 is a block diagram of an example directional acoustic sensor device that may be utilized in the acoustic system of FIG. 1, in accordance with an example.

FIG. 3 is a block diagram of an example directional acoustic sensor device that may be utilized in the acoustic system of FIG. 1, in accordance with an example.

FIGS. 4A-4C are example acoustic channel configurations that may be utilized with a directional acoustic sensor device in the acoustic system of FIG. 1, in accordance with several examples.

FIG. 5A is a cross-sectional, schematic view of an example acoustic system with shared acoustic channels, in accordance with an example.

FIG. 5B is a three-dimensional view of the example acoustic system of FIG. 5A, in accordance with an example.

FIG. 6A is a cross-sectional, schematic view of an example acoustic system with shared acoustic channels and shared sound ports, in accordance with another example.

FIG. 6B is a three-dimensional view of the example acoustic system of FIG. 6A, in accordance with an example.

FIG. 7 depicts plots illustrating measured responses of two acoustic sensor devices that are configured with acoustic channels having shared acoustic channels and a shared sound port, in accordance with an example.

FIG. 8A is a cross-sectional, schematic view of an example acoustic system with shared acoustic channels and shared sound ports, in accordance with another example.

FIG. 8B is a three-dimensional view of the example acoustic system of FIG. 8A, in accordance with an examples.

FIGS. 9A and 9B are cross-sectional, schematic views of an example acoustic system with shared acoustic channels and shared sound ports, in accordance with another example.

FIG. 9C is a three-dimensional view of the example acoustic system of FIGS. 9A and 9B, in accordance with an example.

FIGS. 10A-C are several views of an example acoustic system with shared acoustic channels and shared sound ports, in accordance with another example.

FIGS. 11A-D are several views of an example acoustic system with shared acoustic channels and shared sound ports, in accordance with another example.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Acoustic systems that include multiple acoustic sensor devices, such as microphones, with shared acoustic channels and/or sound ports are disclosed. The multiple acoustic sensor devices that may be included in an acoustic system may include any suitable combination of one or more directional acoustic sensor devices, such as one or more directional microphones, and one or more omnidirectional acoustic sensor devices, such as one or more omnidirectional microphones. For example, the acoustic system may include a directional acoustic sensor device integrated with an omnidirectional acoustic sensor device. As another example, the acoustic system may include two directional acoustic sensor devices integrated together, for example such that the two acoustic sensor devices have directions of sensitivity that are orthogonal with respect to each other. As yet another example, three directional acoustic sensor devices may be integrated together, for example such that the three acoustic sensor devices all have directions of sensitivity that are orthogonal with respect to each. In other examples, other suitable acoustic sensor device configurations may be utilized. Generally, a directional acoustic sensor device includes two sound ports configured to couple respective sides of a transducer to an ambient environment. On the other hand, an omnidirectional acoustic sensor device generally includes a single sound port configured to couple one side of a transducer to an ambient environment, while the other side of the transducer may be exposed to an air volume that is internal to the acoustic sensor device and is at least substantially sealed from the ambient environment.

The acoustic system may also include a plurality of acoustic channels configured to provide couplings between the plurality of acoustic sensor devices and an ambient environment. In aspects of the present disclosure, one or more of the acoustic channels may share one or more shared channel portions. For example, the acoustic system may include a shared channel portion in which one or more of the acoustic channels are allowed to intersect. Because the acoustic system may include acoustic channels that intersect, the multiple acoustic sensor devices may be integrated together with a reduced total physical space or footprint as compared to a system in which individual separate acoustic channels are used for each of the acoustic sensor devices. In some examples, the one or more shared channel portions in the acoustic system may allow for use of one or more shared sound ports in the acoustic system. For example, a shared sound may be used to expose multiple acoustic channels to the ambient environment via a channel portion shared between the multiple acoustic channels. Thus, a total number of sound ports that need to be provided in an end-product device to integrate the multiple acoustic sensor devices into the end-product device may be reduced as compared to a system that does not include any shared acoustic channels or any shared sound ports. As just an example, an acoustic system that includes a directional acoustic sensor device and an omnidirectional acoustic sensor device integrated may be into an end-product device with only two sound ports provided in the end-product device as compared to three sound ports required in a system that does not include any shared acoustic channels and shared sounds ports. As another example, an acoustic system that includes two directional acoustic sensor devices may be integrated into an end-product device with only three sound ports provided in the end-product device as compared to four sound ports required in a system that does not include any shared acoustic channels and shared sound ports. As still another example, an acoustic system that includes three directional acoustic sensor devices integrated into an end-product device with only four sound ports as compared to six sound ports required in a system that does not includes any shared acoustic channels and shared sound ports. In at least some examples, the reductions in total occupied physical space and/or reductions in the total number sound ports may result in reduction of cost of the acoustic system and/or the end-product device. For example, the reduction in the total number of sound ports that need to be provided in the end-product device generally leads to a corresponding reduction in the number of meshes, adhesives, etc. that need to be used in the end-product device, which, in turn, may lead to a reduction in cost of production of the end-product device.

The disclosed acoustic sensor device systems may be useful in a wide variety of microphone applications and contexts, including, for instance, various consumer devices such as smartphones, laptops, and earbuds that includes or are otherwise equipped with microphones. The configuration of the disclosed acoustic sensor device systems may be useful in connection with any device in which there is an interest in listening to sound originating from a specific direction with greater sensitivity than sound originating from other directions.

Although generally described in connection with microphones, the disclosed acoustic systems and devices may be used in other applications and contexts. For instance, the disclosed acoustic sensor device systems are useful in connection with accelerometers, gyroscopes, inertial sensors, pressure sensors, gas sensors, etc. The disclosed acoustic systems and devices are described in the context of excitation by sound waves. However, alternative or additional stimuli may excite the disclosed sensor devices in other contexts.

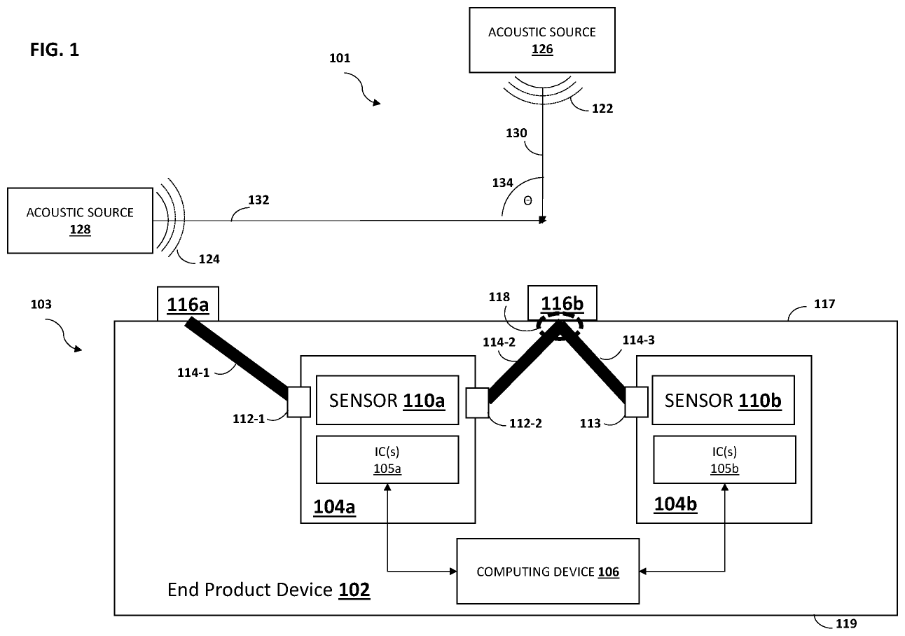

FIG. 1 is a block diagram depicting an example acoustic sensing environment in which an acoustic system with shared acoustic channels and/or shared sound ports may be utilized, in accordance with an example. An end-product device 102 equipped with an acoustic system 103 may be placed in an ambient environment 101 (e.g., ambient air). The end-product device 102 may be an electronic device such as a smartphone, personal computer, headset, TV, robot, etc. The end-product device 102 may be further equipped with a computing device 106. The computing device 106 may be a processor of the end-product device, for example. Although the computing device 106 is illustrated in FIG. 1 as being a part of the end-product device 102 that is externally coupled to the acoustic sensor device 104, the computing device 106 may be external to the end-product device 102, in some examples. For example, the computing device 106 may be a processor of a computer or other electronic device that may be externally connected to the end-product device 102. In yet another example, the computing device 106 may be internal to the acoustic sensor device 104 and/or at least a portion of the functionality described herein with reference to the computing device 106 may be performed internally to the acoustic sensor device 104.

The acoustic system 103 includes multiple acoustic sensor devices (e.g., microphones) 104, including at least a first microphone 104a and a second microphone 104b integrated into the end-product device 102. The first microphone 104a includes a sensing element 110a. The second microphone 104b includes a sensing element 110b. Each of the sensing elements 110a, 110b may include a diaphragm of a MEMS transducer, for example. The first microphone 104a may be a directional microphone that includes two sound ports 112 configured to couple opposite sides of the sensing element 110a to the ambient environment. The second microphone 104b, on the other hand, may be an omnidirectional microphone that includes a single sound port 113 configured to couple one side of the sensing element 110b to the ambient environment, while the other side of the sensing element 110b is exposed to an internal air volume that is at least substantially sealed from the ambient environment. In other examples, other suitable microphone configurations may be utilized. For example, the second microphone 104b may comprise a directional microphone that includes two sound ports 113. In some such examples, the first directional microphone 104a and the second directional microphone 104b may be incorporated into the end-product 102 in a configuration (sometimes referred to as an “XY” configuration) in which the first directional microphone 104a and the second directional microphone 104b have sensitivities that are orthogonal with respect to each other.

Although the acoustic system 103 is illustrated in FIG. 1 as including two microphones 104, the acoustic system 103 may include more than two microphones 104, in some examples. For example, the acoustic system 103 may include two directional microphones 104 (arranged, for example, in “XY” configuration) and may further include an omnidirectional microphone 104. In another example, the acoustic system 103 may include three directional microphones 104 arranged in a configuration (sometimes referred to as an “XYZ” configuration) in which the three directional microphone 104 have respective sensitivities that are orthogonal to each other, for example. In still another example, the acoustic system 103 may include three directional microphones 104 (arranged, for example, in “XYZ” configuration) and may further include an omnidirectional microphone 104. In other examples, other suitable microphone configurations may be utilized. For example, the acoustic system 103 may include a suitable arrangement that includes more than four microphones 104.

The acoustic system 103 includes a plurality of acoustic channels 114 configured to provide respective couplings between sound ports of the microphones 104 and the ambient environment. For example, the acoustic system 103 includes a first acoustic channel 104-1 configured to provide a coupling between the sound port 112-1 of the first microphone 104 and the ambient environment and a second acoustic channel 104-2 configured to provide a coupling between the sound port 112-2 of the first microphone 104a and the ambient environment. The acoustic system 103 also includes a third acoustic channel 114-3 configured to provide a coupling between the sound port 113 of the second microphone 104b and the ambient environment. The acoustic system 103 may further include a plurality of sound ports 116 disposed on, or otherwise embedded into, the end-product device 102 to couple the acoustic channels 114 to the ambient environment. For example, the acoustic system 103 may include a first sound port 116a that may lay on or be otherwise embedded in an edge 117 of the end-product device 102 and a second sound port 116b that may lay on or be otherwise embedded in the edge 117 of the end-product device 102.

It is noted that although the first sound port 116a and the second sound port 116b of the end-product device 102 are illustrated in FIG. 1 as being on the same edge 117 of the end-product device 102, the first sound port 116a and the second sound port 116b may instead lay on or be otherwise embedded in different edges of the end-product device 102. As just an example, the first sound port 116a and the second sound port 116b may lay or be otherwise embedded in opposing edges 117, 119 of the end-product device 102. In some examples, depending on the number and configuration of microphones 104 included in the acoustic system 103, more than two sound ports 116 may be provided in the end-product 102, with the sound ports 116 laying on or otherwise being embedded in one or more edges of the end-product device 102. In some examples, the acoustic system 103 may include more than one shared sound port 116.

In an example, the acoustic system 103 includes one or more channel portions that are shared between multiple ones of the acoustic channels 114. For example, a shared channel portion in the acoustic channel 114 may comprise a channel portion in which two or more of the acoustic channels 114 intersect each or otherwise come in contact with one another. The one or more shared channel portions may be shared between acoustic channels that are configured to provide couplings between different ones of the microphones 104 and the ambient environment. For example, the acoustic system 103 may include a shared channel portion 118 that includes a portion of the second acoustic channel 114-2 configured to provide a coupling between the sound port 112-2 of the first microphone 104a and the ambient environment and a portion of the third acoustic channel 114-3 configured to provide a coupling between the sound port 113 of the second microphone 104b and the ambient environment. In at least some examples, because the acoustic system 103 includes one or more shared portions 118 in which multiple acoustic channels 114 are allowed to intersect or otherwise connect, the total amount of physical space occupied by the acoustic system 103 may be reduced. Further, in at least some examples, because the acoustic system 103 includes one or more shared portions 118 in which multiple acoustic channels 114 are allowed to intersect or otherwise connect, one or more shared sound ports 116 may be used to expose multiple acoustic channels 114 to the ambient environment. For example, as illustrated in FIG. 1, the shared channel portion 118 allows a single shared sound port 116b to expose both the second acoustic channel 114-2 and the third acoustic channel 114-3 to the ambient environment. Thus, the total number of sound ports 116 needed to integrate the multiple microphones 104 into the end-product device may be reduced as compared to a system that does not include any shared channel portions and shared sound ports.

Sound waves 122 and 124 may be emitted by a first acoustic source 126 and a second acoustic source 128, respectively, and may travel therefrom in the ambient environment 101. As depicted, the sound waves 122 are propagated radially and include a direct path 130. Sound waves 124 are propagated radially and include a direct path 132 at an angle 134 from the direct path 130. Sound waves 122 thus travel along the path 130 that is parallel to the edges 117 and 119, while sound waves 124 travel along the path 132 that is perpendicular to the surfaces 117 and 119. In accordance with the configuration of the acoustic system 103 illustrated in FIG. 1, the first microphone 104a may capture the portion of the ambient environment 101 with sound waves 124 parallel to the edge 117 with increased sensitivity relative to the portion of the ambient environment 101 with sound waves 122 perpendicular to the edge 117. For example, the first microphone 104a may capture sound waves 124 with at least 15 dB or 20 dB greater sensitivity than sound waves 122 at certain audible frequencies. Further, in accordance with the configuration of the acoustic system 103 illustrated in FIG. 1, the second microphone 104b may omnidirectionally capture sound waves traveling in the ambient environment 101. Thus, the second microphone 104b may capture the sound waves 122 and the sound waves 124 with at least substantially equal sensitivity. In another example in which the second microphone 104b is a directional microphone and an additional sound port 116 is provided in the end-product 102, the sound ports 116 may be arranged in the end-product device 102 such that the second microphone 104b may capture the portion of the ambient environment 101 with sound waves 122 perpendicular to the edge 117 with increased sensitivity relative to the portion of the ambient environment 101 with sound waves 124 parallel to the edge 117. For example, in such system, the second microphone 104 b may capture sound waves 122 with at least 15 dB or 20 dB greater sensitivity than sound waves 124 at certain audible frequencies.

The microphones 104 may each also include one or more integrated circuit (IC) devices 105. The one or more IC devices 105 may include one or more application specific integrated circuit (ASIC) devices, for example. The one or more IC devices 105 may be configured to read out electrical signals generated based on movement of the sensing element 110 of the respective microphones 104, and to generate one or more sensor output signals based on the electrical signals. For example, one or more IC devices 105a may be included in the first microphone 104a to read out electrical signals generated based on movement of the sensing element 110a of the first microphone 104a, and to generate one or more sensor output signals based on the electrical signals. Similarly, one or more IC devices 105b may be included in the second microphone 104b to read out electrical signals generated based on movement of the sensing element 110b of the second microphone 104b, and to generate one or more sensor output signals based on the electrical signals.

The one or more IC devices 105 may be configured to provide the one or more sensor output signals to the computing device 106. The computing device 106 may be configured to further process sensor output signals received from the plurality of sensors 104, in some examples. For example, the computing device 106 may be configured to mathematically combine the sensor output signals to generate a combined sensor output signal having a desired directionality pattern (e.g., a cardioid pattern, a hyper-cardioid pattern, a super-cardioid pattern, etc.) In some aspects, the computing device 106 may be configured to additionally or alternatively perform other mathematical manipulations based on the sensor output signals from the plurality of microphones 104. For example, the computing device 106 may be configured to multiply a directional sensor output signal (e.g., received from the first microphone 104a) with an omnidirectional sensor output signal (e.g., received from the second microphone 104a) to determine a sound intensity. In various examples, because of the one or more shared channel portions 118 and/or one or more shared sound ports 116 in the acoustic system 103, such directionality patterns and other sensor signal operations may be performed with the acoustic system 103 occupying less physical space and/or using fewer total number of sound ports 116 as compared to systems that do not include any shared acoustic channels or shared sound ports.

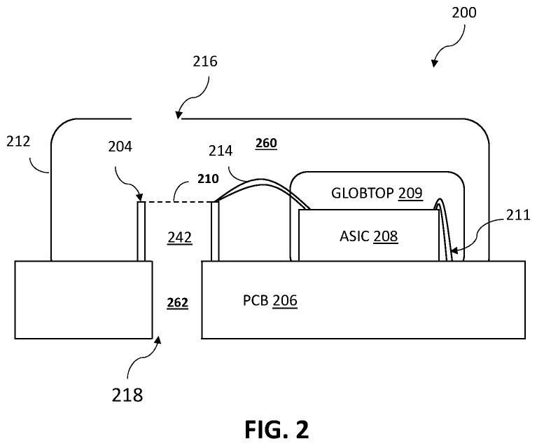

Turning now to FIG. 2, a cross-sectional, schematic view of an acoustic sensor device 200 configured as a directional acoustic sensor device, according to an example, is depicted. The acoustic sensor device 200 may be a microphone, for example. The acoustic sensor device 200 may correspond to the microphone 104a of FIG. 1. The acoustic sensor device 200 may include a transducer 204. The transducer 204 may be a MEMS transducer, for example. In other examples, however, the transducer 204 may comprise a suitable transducer other than a MEMS transducer. The transducer 204 may be attached to or otherwise supported by a PCB or other substrate 206 (generally referred to herein as “PCB 206”). The PCB 206 may comprise one or more layers. In an example in which the PCB 206 comprises multiple layers, respective ones of the multiple layers may be separated from one another by a dielectric material. The one or more layers of the PCB 206 may include conductive traces that may route electrical signals in the PCB 206. The acoustic sensor device 200 may also include a lid or other enclosure 212 (generally referred to herein as “lid 212”). The lid 212 may be placed over the PCB 206 to enclose the components of the acoustic sensor device 200 mounted on or otherwise attached to the PCB 206. The lid 212 may be composed of, or otherwise include, a metal, plastic, ceramic, or other material. The lid 212 and the PCB 206 may form a package of the acoustic sensor device 200. In other examples, a package of the acoustic sensor device 200 may be formed in other suitable manners. The transducer 204 may include a diaphragm or other sensing element 210 positioned over a cavity 242. The cavity 242 may be formed in the first MEMS transducer 204 through various microfabrication practices including, for instance, deep reactive ion etching (DRIE). The diaphragm 210 includes a first side that faces outwards with respect to the cavity 242 and a second side that faces the cavity 242. In an example, the diaphragm 210 may comprise a cantilever diaphragm structure that is attached on one end and is free to move on the other end. In another examples, the diaphragm 210 may comprise another suitable structure, such as a fixed-fixed structure that is fixed on more than two sides, such as a diaphragm that is fixed or anchored on all sides around the perimeter.

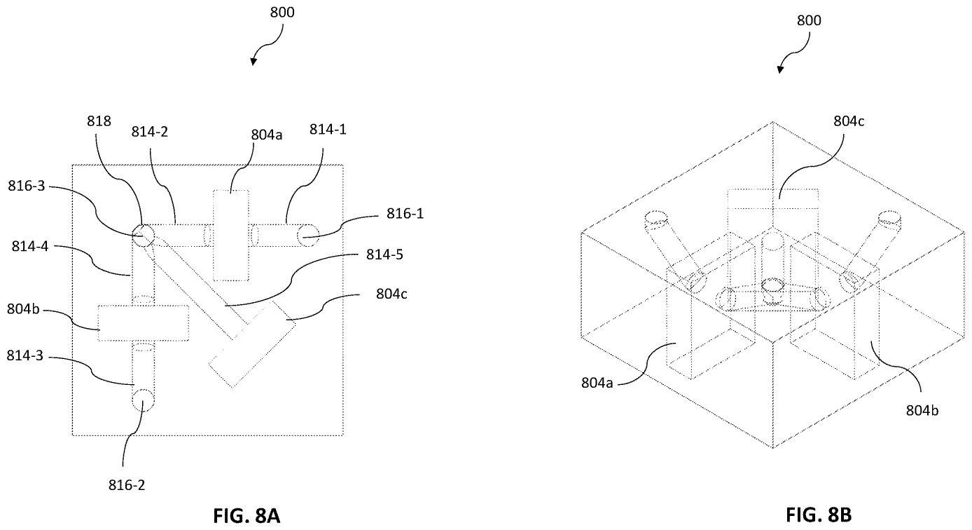

The acoustic sensor device 200 may include a first sound port 216 formed in the lid 212 and a second sound port 218 formed in the PCB 206. A first air volume 260 may be formed in the package of the acoustic sensor device 200 between the PCB 206 and the lid 212 and may be configured to be exposed to the ambient environment via the first sound port 216. A second air volume 262 may comprise the cavity 242 in the MEMS transducer 204 and may be configured to be exposed to the ambient environment via the second sound port 218. The diaphragm or other sensing element 210 may thus have two opposing sides exposed to the ambient environment, and may sense a pressure gradient between the opposing sides of the diaphragm 210 exposed to the ambient environment. Because the diaphragm 210 of the MEMS transducer 204 has two opposing sides that are exposed to the ambient environment, and thus the first transducer 204 senses the pressure gradient between the opposing sides of the diaphragm 210 exposed to the ambient environment, the MEMS transducer 204 produces a directional polar pattern. For example, the MEMS transducer 204 may produce a dipole, or FIG. 8, polar pattern. It is noted that although the first sound port 216 is illustrated as being formed in the lid 212, the first sound port 216 may instead be embedded in the PCB 206, in some examples. In this case, the first sound port 216 may be placed with a suitable distance from the second sound port 218, such that the first sound port 216 still couples the ambient environment with the first air volume 260.

The acoustic sensor device 200 may also include an ASIC 208. The ASIC 208 may correspond to the one or more IC devices 105a in FIG. 1. The ASIC 208 may be mounted on or otherwise attached to the PCB 206. The ASIC 208 may be covered by a protective globtop 209. The ASIC 208 may be electrically coupled to the MEMS transducer 204. For example, the MEMS transducer 204 and ASIC 208 may be electrically connected by wire bonds 214, either directly to each other, or via traces on the PCB 206. The ASIC 208 may also be electrically connected to the PCB 206 by wire bonds 211. In other examples, the MEMS transducer 204 and the ASIC 208 may be attached and/or electrically coupled using other suitable methods. For example, the MEMS transducer 204 may be attached to the PCB 206 using flip chip technology.

The ASIC 208 may be configured to read out electrical signals generated by the MEMS transducer 204 based on movement of the diaphragm 210, and to generate a sensor output based on the electrical signals read out from the first transducer 204. In an example, the ASIC 208 may generate a directional (e.g., a dipole) sensor output signal based on the electrical signals read out from the transducer 204. The sensor output generated by the ASIC 208 may be provided for further processing to an external computing device, such as, for example, the computing device 106 in FIG. 1.

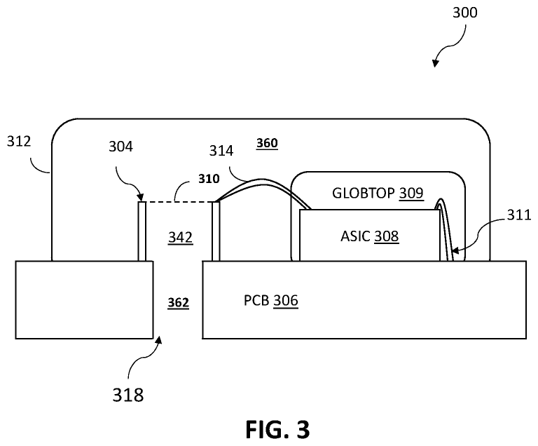

Turning now to FIG. 3, a cross-sectional, schematic view of an acoustic sensor device 300 configured as an omnidirectional acoustic sensor device, according to an example, is depicted. The acoustic sensor device 300 may be a microphone, for example. The acoustic sensor device 300 may correspond to the microphone 104b of FIG. 1. The acoustic sensor device 300 is generally similar to the acoustic sensor device 200 of FIG. 2 and includes like-numbered elements with the acoustic sensor device 200 that are not discussed in detail below for the purpose of brevity. The acoustic sensor device 300 may include a transducer 304 that may be the same as or similar to the transducer 204 of FIG. 2. The transducer 304 may be a MEMS transducer, for example. Unlike the acoustic sensor device 200 of FIG. 2 that includes two sound ports 216, 218, the acoustic sensor device 300 includes only a single sound port 318. A lid 312 of the acoustic sensor device 300 does not include a sound port. Thus, an air volume 360 of the acoustic sensor device 300 is at least substantially sealed from the ambient environment.

The sound port 318 may be configured to expose one side of a diaphragm 310 of the acoustic sensor device 300 to the ambient environment, while the other side of the diaphragm 310 may be exposed to the sealed air volume 306. In some cases, the air volume 360 is generally sealed from the ambient environment but the acoustic sensor device 300 may include a vent hole or other small opening (e.g., in the lid 312) exposing the air volume 360 to the ambient environment to equalize the direct current (DC), or low frequency, pressure changes in the ambient environment. Because the diaphragm 310 is exposed on only one side to the ambient environment and is exposed on the other side to the sealed air volume 306, the MEMS transducer 304 may sense pressure at the single exposed side of the diaphragm 310 exposed to the ambient environment relative to a reference pressure in the sealed air volume 360. The MEMS transducer 304 may therefore produce an omnidirectional polar pattern.

In an example, the diaphragm 310 of the acoustic sensor device 300 may have the same structure as the diaphragm 210 of the acoustic sensor device 200 of FIG. 2. In another example, the diaphragm 310 of the acoustic sensor device 300 may have a different structure from the diaphragm 210 of the acoustic sensor device 200 of FIG. 2. For example, the diaphragm 210 and the diaphragm 310 may comprise different structures that are optimized for, respectively, directional sensing operation and omnidirectional sensing operation. As just an example, the diaphragm 210 may comprise a cantilever diaphragm structure that is attached on one end and is free to move on the other end, and the diaphragm 310 may comprise a fixed-fixed structure that is fixed on both ends or is fixed around the perimeter. In other examples, the diaphragm 210 and/or the diaphragm 310 may comprise another suitable structure.

As noted above with reference to FIG. 1, in some examples, an acoustic system may include a directional acoustic sensor device (e.g., the acoustic sensor device 200 of FIG. 2) and an omnidirectional acoustic sensor device (e.g., the acoustic sensor device 300 of FIG. 3). In an example, such acoustic system may include a first sound port and a first acoustic channel configured to expose a first side of a diaphragm (e.g., the diaphragm 210 in FIG. 2) of the directional acoustic sensor device to the ambient environment. The acoustic system may also include a second, shared, sound port and a second, shared, acoustic channel configured to couple both a second side of the diaphragm (e.g., the diaphragm 210 in FIG. 2) of the directional acoustic sensor device and one side of a diaphragm (e.g., the diaphragm 310 in FIG. 3) of the omnidirectional acoustic sensor device to the ambient environment, while a second side of the diaphragm (e.g., the diaphragm 310 in FIG. 3) of the omnidirectional acoustic sensor device is exposed to a sealed air volume.

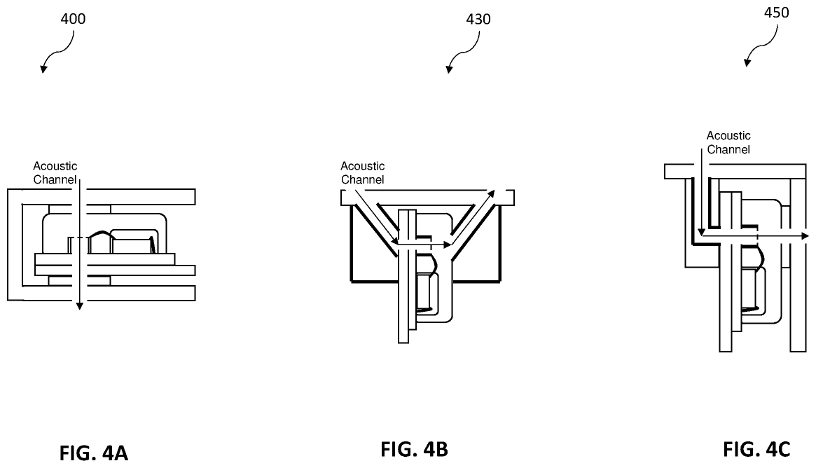

FIGS. 4A-4C are example acoustic channel configurations that may be utilized in an acoustic system, such as the acoustic system 103 in FIG. 1, to provide respective coupling between two sound ports of the directional acoustic sensor and an ambient environment, in accordance with several examples. The acoustic channel configurations illustrated in FIGS. 4A-4C may be utilized to integrate a directional microphone, such as the microphone 104a in FIG. 1, into an end-product device, such as the end-product 102 in FIG. 1. Referring first the FIG. 4A, in an example, a straight acoustic channel configuration 400 may be utilized. As just an example, the straight acoustic channel configuration 400 may be utilized to integrate a directional microphone into an end-product with sound ports being provided on opposite edges of the end-product device, such as on opposing edges 117, 119 of the end-product device 102 in FIG. 1. Referring now to FIG. 4B, in another example, a “V-shaped” or “U-shaped” acoustic channel configuration 430 may be utilized. As just an example, the “V-shaped” or “U-shaped” acoustic channel configuration 430 may be utilized to integrate a directional microphone into an end-product with sound ports being provided on a same edges of the end-product device, such as on the edge 117 of the end-product device 102 in FIG. 1. Referring now to FIG. 4C, in another example, an “L-shaped” acoustic channel configuration 450 may be utilized. As just an example, the “L-shaped” acoustic channel configuration 450 may be utilized to integrate a directional microphone into an end-product with sound ports being provided on perpendicular edges of the end-product device.

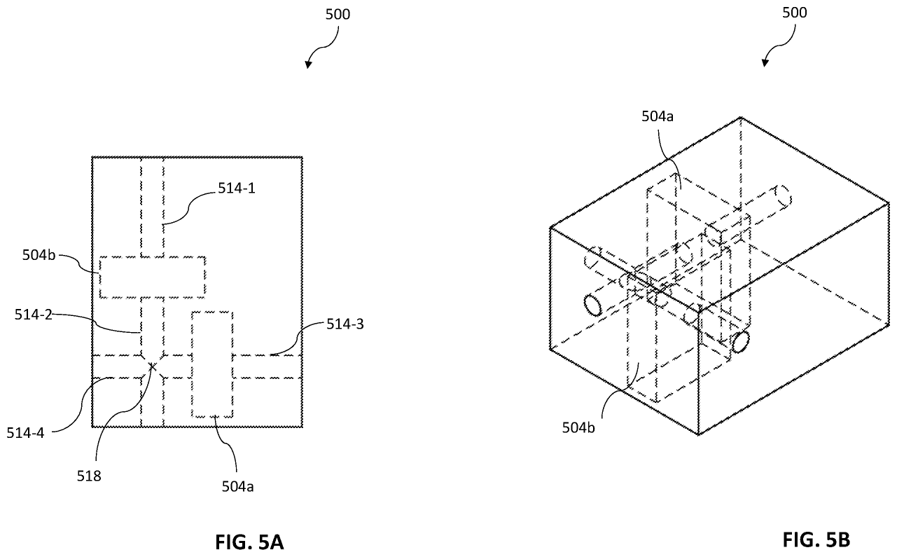

FIG. 5A is a cross-sectional, schematic view of an example acoustic system 500 with shared acoustic channels, in accordance with an example. FIG. 5B is a three-dimensional view of the example acoustic system 500 of FIG. 5A, in accordance with an example. FIGS. 5A and 5B include corresponding elements that are, in some instances, not labeled in FIG. 5B in an effort to not obscure the drawing. In an example, the acoustic system 500 corresponds to the acoustic system 103 of FIG. 1. The acoustic system 500 includes a first acoustic sensor device 504a and a second acoustic sensor device 504b. Each of the first acoustic sensor device 504a and the second acoustic sensor device 504b may comprise a directional acoustic sensor device, such as a directional microphone. In an example, each of the first directional acoustic sensor device 504a and the second directional acoustic sensor device 504b may correspond to the directional acoustic sensor device 200 of FIG. 2. The acoustic system 500 also includes a plurality of acoustic channels 514 configured to provide couplings between sound ports of the acoustic sensor devices 504 to an ambient environment. For example, the acoustic system 500 includes a first acoustic channel 514-1 and a second acoustic channel 514-2 configured to provide respective couplings between respective sound ports of the first acoustic sensor device 504a and the ambient environment. The acoustic system 500 also includes a third acoustic channel 514-3 and a fourth acoustic channel 514-4 configured to provide respective couplings between respective sound ports of the second acoustic sensor device 504b and the ambient environment.

The acoustic system 500 includes a shared channel portion 518 at which the second acoustic channel 514-2 intersects with the fourth acoustic channel 514-4. The shared channel portion 518, accordingly, includes a portion of the second acoustic channel 514-2 and a portion of the fourth acoustic channel 514-4. The shared channel portion 518 allows for integration of the first acoustic sensor device 504a and the second acoustic sensor device 504b in the acoustic system 500 in a smaller footprint as compared to a system in which no sharing of acoustic channels is utilized. For example, the acoustic sensor device 504a, 504b, may be placed closer together than would be possible in a system in which no sharing of acoustic channels is utilized. In an example, the first acoustic sensor device 504a and the second acoustic sensor device 504b may be integrated together to have orthogonal directions of sensitivity in an “XY” configuration without having to place the first acoustic sensor device 504a and the second acoustic sensor device 504b side-by-side completely independent of one another.

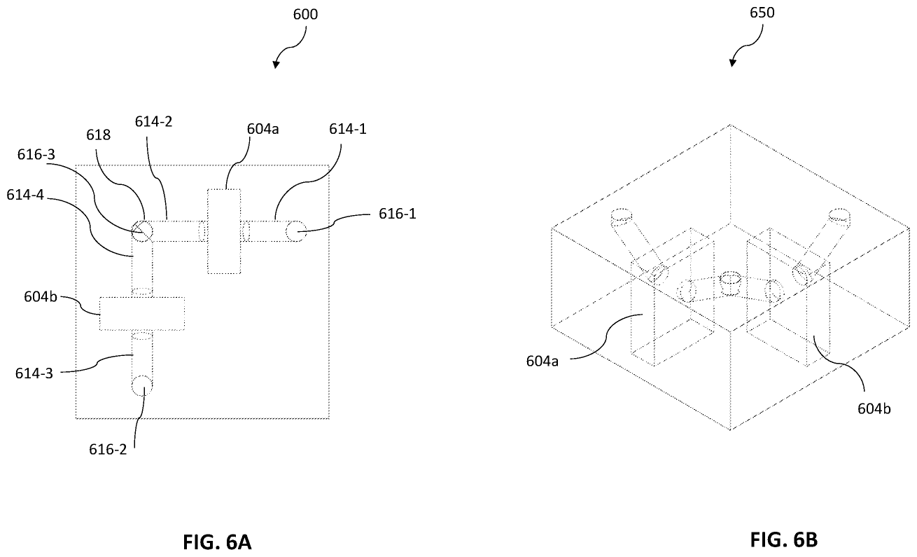

FIG. 6A is a cross-sectional, schematic view of an example acoustic system 600 with shared acoustic channels and shared sound ports, in accordance with another example. FIG. 6B is a three-dimensional view of the example acoustic system 600 of FIG. 6A, in accordance with an example. FIGS. 6A and 6B include corresponding elements that are, in some instances, not labeled in FIG. 6B in an effort to not obscure the drawing. In an example, the acoustic system 600 corresponds to the acoustic system 103 of FIG. 1. The acoustic system 600 includes a first acoustic sensor device 604a and a second acoustic sensor device 604b. Each of the first acoustic sensor device 604a and the second acoustic sensor device 604b may comprise a directional acoustic sensor device, such as a directional microphone. Each of the first directional acoustic sensor device 604a and the second directional acoustic sensor device 604b may correspond to the directional acoustic sensor device 200 of FIG. 2, for example.

The acoustic system 600 includes a plurality of acoustic channels 614 configured to provide couplings between sound ports of the acoustic sensor devices 604 to an ambient environment. For example, the acoustic system 600 includes a first acoustic channel 614-1 and a second acoustic channel 614-2 configured to provide respective couplings between respective sound ports of the first acoustic sensor device 604a and the ambient environment. The acoustic system 600 also includes a third acoustic channel 614-3 and a fourth acoustic channel 614-4 configured to provide respective couplings between respective sound ports of the second acoustic sensor device 604b and the ambient environment. The acoustic system 600 may also include a plurality of sound ports 616, including a first sound port 616-1, a second sound port 616-2, and a third sound port 616-3, configured to expose the acoustic channels 614 to the ambient environment.

The acoustic system 600 includes a shared channel portion 618 at which the second acoustic channel 614-2 and the fourth acoustic channel 614-4 intersect. The shared channel portion 618 thus includes a portion of the second acoustic channel 614-2 and a portion of the fourth acoustic channel 614-4. Because the acoustic system 600 includes the shared channel portion 618 at which the second acoustic channel 614-2 and the fourth acoustic channel 614-4 intersect, a single sound port may be used to expose the second acoustic channel 614-2 and the fourth acoustic channel 614-4 to an ambient environment. For example, the third sound port 616-3 may be a shared sound port used to expose the second acoustic channel 614-2 and the fourth acoustic channel 614-4 to an ambient environment. The shared sound port 616-3 may thus be shared between the first acoustic sensor device 604a and the second acoustic sensor device 604b.

In an example, the first acoustic sensor device 604a and the second acoustic sensor device 604b in the acoustic system 600 may be integrated together to have orthogonal directions of sensitivity in an “XY” configuration. The acoustic channels 614 may be collectively arranged in a “V-shaped” or “U-shaped” acoustic channel configuration such as, for example, the configuration 430 of FIG. 4B. In the “XY” configuration, the first sound port 616-1 and the shared sound port 616-3 may be in-plane sound ports located along a first axis (“X axis”) and the second sound port 616-2 and the shared sound port 616-3 may be in-plane sound ports located along a second axis (“Y axis”) that is perpendicular to the first axis. In this example configuration, sound waves traveling in the direction perpendicular to the X axis may hit the first sound port 616-1 and the shared sound port 616-3 at the same time (or at least substantially the same time), but hit the second sound port 613-2 at a different time.

Thus, a pressure difference may be created between the second sound port 613-2 and the shared sound port 616-3 while no significant pressure difference is created between the first sound port 613-1 and the shared sound port 616-3. As a result, the sound waves traveling in the direction perpendicular to the X axis may excite the second acoustic sensor device 604b but not excite the first acoustic sensor device 604a. On the other hand, sound waves traveling in the direction perpendicular to Y axis may hit the second sound port 616-2 and the shared sound port 616-3 at the same time (or at least substantially the same time), but hit the first sound port 613-1 at a different time. Thus, a pressure difference may be created between the first sound port 613-1 and the shared sound port 616-3 while no significant pressure difference is created between the second sound port 613-2 and the shared sound port 616-3. Thus, the sound waves traveling in the direction perpendicular to the Y axis will excite the first acoustic sensor device 604a but not excite the second acoustic sensor device 604b.

Accordingly, only one of the acoustic sensor devices 604a, 604b may be excited for a given direction of travel of sound waves. As a result, the acoustic sensor devices 604a, 604b may maintain independent directionality as if the acoustic sensor devices 604a, 604b were completely separate from one another, in an example.

In various examples, because the acoustic system 600 includes a shared channel portion and a shared sound port, the first acoustic sensor device 604a and the second acoustic sensor device 604b may be integrated into an end-product device with a fewer number of sound ports provided in the end-product device as compared to a system in which no sharing of acoustic channels and no sharing of sound ports is utilized. For example, the first acoustic sensor device 604a and the second acoustic sensor device 604b may be integrated into an end-product device with only three sound ports provided in the end-product device as compared to four sound ports that would be needed in a system in which no sharing of acoustic channels and no sharing of sound ports is utilized.

Referring to FIG. 6B, it is noted that the acoustic channels 614 may be arranged in various configurations in the acoustic system 600, in various examples. For example, the acoustic channels 614 may be arranged such that the shared sound port 616-3 that couples both the second acoustic channel 614-2 and the fourth acoustic channel 614-4 to the ambient environment is located at one edge, and the sound ports 616-1, 616-2 that couple the first acoustic channel 614-1 and the third acoustic channel 614-3 to the ambient environment are located on another, e.g., opposing, edge. As another example, the acoustic channels 614 may be arranged such that the shared sound port 613-3 that couples both the second acoustic channel 614-2 and the fourth acoustic channel 614-4 to the ambient environment is located on a same edge as the sound ports 616-1, 616-2 that couple the first acoustic channel 614-1 and the third acoustic channel 614-3 to the ambient environment. In other examples, other suitable arrangements of the acoustic channels 614 may be utilized.

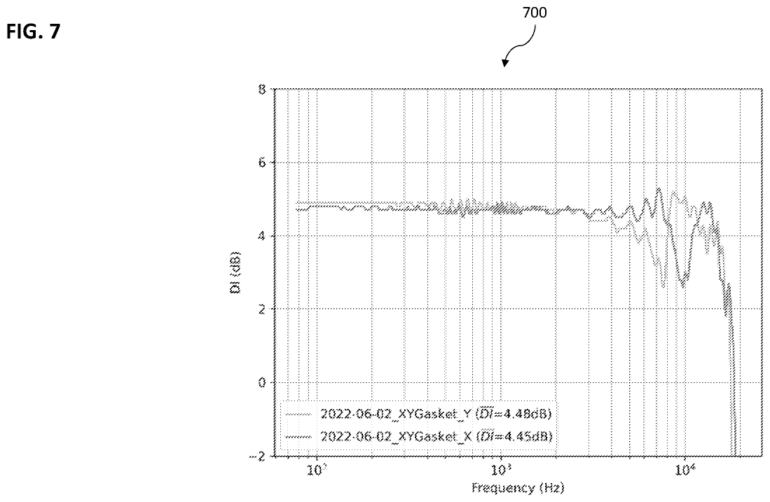

Referring briefly to FIG. 7, plots 700 illustrate measured responses, or directivity index, of two directional acoustic sensor devices that are configured with shared acoustic channels and a shared sound port. As can be seen in the plots 700, the shared channel portion and the shared channel port allow construction of an acoustic system with relatively consistent directivity and across the audible frequency range.

FIG. 8A is a cross-sectional, schematic view of an example acoustic system 800 with shared acoustic channels and shared sound ports, in accordance with another example. FIG. 8B is a three-dimensional view of the example acoustic system 800 of FIG. 8A, in accordance with an examples. FIGS. 8A and 8B include corresponding elements that are, in some instances, not labeled in FIG. 8B in an effort to not obscure the drawing. The acoustic system 800 is similar to the acoustic system 600 of FIGS. 6A and 6B and includes like-numbered elements with the acoustic system 600 that are not discussed in detail below for the purpose of brevity. The acoustic system 800 may include a first acoustic sensor device 804a corresponding to the first acoustic sensor device 604a and a second acoustic sensor device 804b corresponding to the second acoustic sensor device 604b. Each of the first acoustic sensor device 804a and the second acoustic sensor device 804b may comprise a directional acoustic sensor device, such as a directional microphone. Each of the first directional acoustic sensor device 804a and the second directional acoustic sensor device 804b may correspond to the directional acoustic sensor device 200 of FIG. 2, for example. In an example, the first acoustic sensor device 804a and the second acoustic sensor device 808b may be arranged to have orthogonal directions of sensitivity in the “XY” configuration. The acoustic system 800 further includes a third acoustic sensor device 804c. The third acoustic sensor device 804c comprises an omnidirectional acoustic sensor device, such as an omnidirectional microphone. The omnidirectional acoustic sensor device 804c may correspond to the acoustic sensor device 300 of FIG. 3, for example. The acoustic system 800 includes a fifth acoustic channel 814-5 configured to provide a coupling between respective a single sound port of the third acoustic sensor device 804c and the ambient environment.

The acoustic system 800 includes a shared channel portion 818 at which the second acoustic channel 814-2, the fourth acoustic channel 814-4, and the fifth acoustic channel 814-5 intersect. The shared channel portion 818 thus includes a portion of the second acoustic channel 814-2, a portion of the fourth acoustic channel 814-4, and a portion of the fifth acoustic channel 814-5. Because the acoustic system 800 includes the shared channel portion 818 at which the second acoustic channel 814-2, the fourth acoustic channel 814-4, and the fifth acoustic channel 814-5 intersect, a single sound may be used to expose the second acoustic channel 814-2, the fourth acoustic channel 814-4, and the fifth acoustic channel 814-5 to an ambient environment. For example, the sound port 816-3 may be a shared sound port used to expose the second acoustic channel 814-2, the fourth acoustic channel 814-4, and the fifth acoustic channel 814-5 to an ambient environment. The third sound port 816-3 may thus be shared between the first acoustic sensor device 804a, the second acoustic sensor device 804b, and the acoustic sensor device 804c.

Accordingly, because the acoustic system 800 includes a shared channel portion and a shared sound port, the first acoustic sensor device 804a, the second acoustic sensor device 804b, and the acoustic sensor device 804c may be integrated into an end-product device with a fewer number of sound ports provided in the end-product device as compared to a system in which no sharing of acoustic channels and no sharing of sound ports is utilized. For example, the first acoustic sensor device 804a, the second acoustic sensor device 804b, and the acoustic sensor device 804c may be integrated into an end-product device with only three sound ports provided in the end-product device as compared to five sound ports that would be needed in a system in which no sharing of acoustic channels and no sharing of sound ports is utilized.

Referring to FIG. 8B, it is noted that the acoustic channels 814 may be arranged in various configurations in the acoustic system 800, in various examples. For example, the acoustic channels 814 may be arranged such that the shared sound port 816-3 that couples the second acoustic channel 814-2, the fourth acoustic channel 814-4, and the fifth acoustic channel 814-5 to the ambient environment is located at one edge, and the sound ports 816-1, 816-2 that couple the first acoustic channel 814-1 and the third acoustic channel 814-3 to the ambient environment are located on another, e.g., opposing, edge. As another example, the acoustic channels 814 may be arranged such that the shared sound port 813-3 that couples the second acoustic channel 814-2, the fourth acoustic channel 814-4, and the fifth acoustic channel 814-5 to the ambient environment is located on a same edge as the sound ports 816-1, 816-2 that couple the first acoustic channel 814-1 and the third acoustic channel 814-3 to the ambient environment. In other examples, other suitable arrangements of the acoustic channels 614 may be utilized.

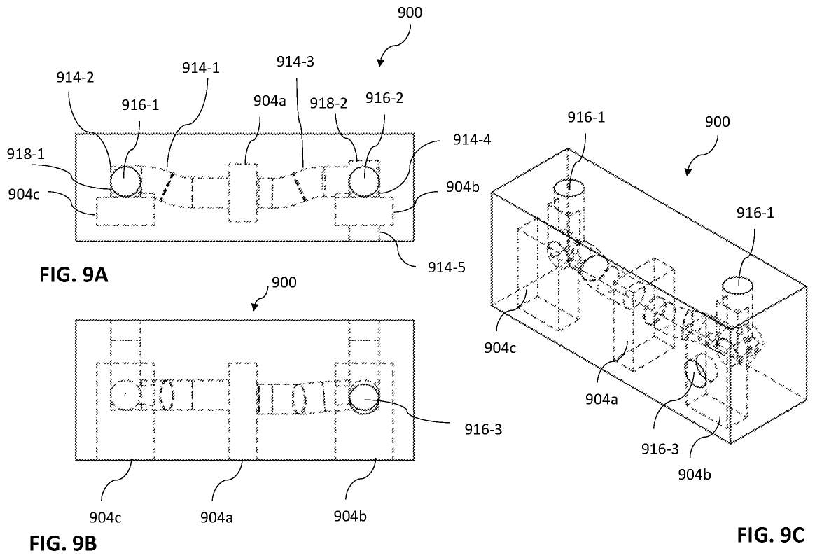

FIGS. 9A and 9B are cross-sectional, schematic views of an example acoustic system 900 with shared acoustic channels and shared sound ports in accordance with an example. FIG. 9C is a three-dimensional view of the example acoustic system 900 of FIGS. 9A and 9B, in accordance with an example. FIGS. 9A and 9B include corresponding elements that are, in some instances, not labeled in FIG. 9B in an effort to not obscure the drawing. The acoustic system 900 is similar to the acoustic system 800 of FIGS. 6A and 6B and includes like-numbered elements with the acoustic system 800 that are not discussed in detail below for the purpose of brevity. Similar to the acoustic system 800, the acoustic system 900 includes a first directional acoustic sensor device 904a, a second directional acoustic sensor device 904b and an omnidirectional acoustic sensor device 904c. The acoustic system 900 also includes a plurality of acoustic channels 914 configured to provide couplings between sound ports of the acoustic sensor device 904 and an ambient environment. Unlike in the acoustic system 800, in the acoustic system 900, the acoustic sensor devices 904 and the acoustic channels are arranged such that the acoustic system 900 includes two shared channel portions and two shared sound ports. A first shared channel portion 918-1 includes a portion of a first acoustic channel 914-1 configured to provide a coupling between a first sound port of the first acoustic sensor device 904a and an ambient environment and a portion of a second acoustic channel 914-2 configured to provide a coupling between a sound port of the third acoustic sensor device 904c and the ambient environment. A first shared sound port 916-1 exposes both the first acoustic channel 914-1 and the second acoustic channel 914-2 to the ambient environment. A second shared channel portion includes a portion of a third acoustic channel 914-3 configured to provide a coupling between a second sound port of the first acoustic sensor device 904a and the ambient environment and a portion of an acoustic channel 914-4 configured to provide a coupling between a first sound port of the second acoustic sensor device 904b and the ambient environment. A fifth, unshared, acoustic channel 914-5 and a third, unshared, sound port 916-3 are provided to couple a second sound port of the second acoustic sensor device 904b to the ambient environment.

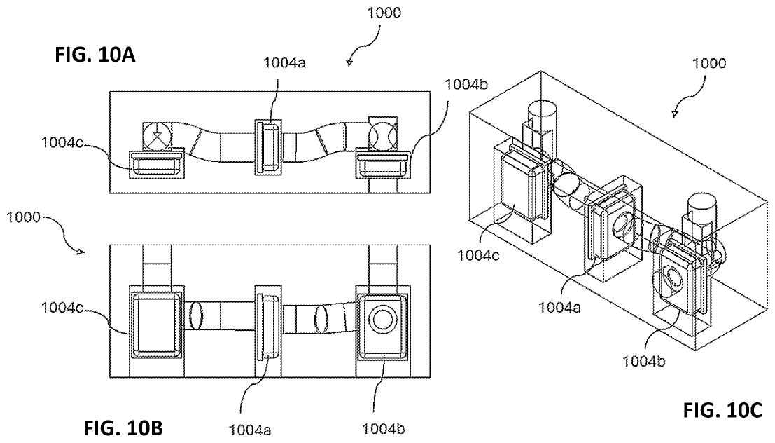

Referring briefly to FIGS. 10A-C, an example acoustic system 1000 is generally the same as the acoustic sensor system 900 of FIGS. 9A-C, in accordance with an example. The acoustic system 1000 is generally the same as the acoustic sensor system 900 except that in the acoustic system 1000, the acoustic sensor devices 904a, 90b, 904c are replaced with microphones 1004a, 1000b, 1004c. In the acoustic system 1000, the microphones 1004a, 1000b, 1004c and corresponding acoustic arranged in the same manner as the acoustic system 900 such that the acoustic sensor system 1000 includes two shared channel portions and two shared sound ports.

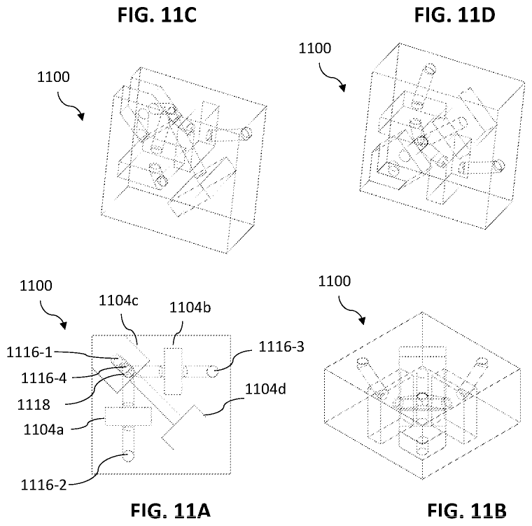

FIGS. 11A-D illustrate several views of an example acoustic system 1100 with shared acoustic channels and a shared sound port, in accordance with an example. The acoustic system 1100 includes at least a first acoustic sensor device 1104a, a second acoustic sensor device 1104b, and a third acoustic sensor device 1104c. Each of the first acoustic sensor device 1104a, the second acoustic sensor device 1104b, and the third acoustic sensor device 1104c may comprise a directional acoustic sensor device, such as a directional microphone. Each of the first acoustic sensor device 1104a, the second acoustic sensor device 1104b, and the third acoustic sensor device 1104c may comprise a directional acoustic sensor device that may correspond to the directional acoustic sensor device 200 of FIG. 2, for example. In an example, the first acoustic sensor device 1104a, the second acoustic sensor device 1104b, and the third acoustic sensor device 1104c may be arranged in the acoustic system 1100 to have respective directions of sensitivity that are orthogonal with respect to one another, in the “XYZ” configuration.

The acoustic system 1100 may include a shared channel portion 1118 that includes respective portions of respective acoustic channels configured to provide couplings between respective first sound ports of the first acoustic sensor device 1104a, the second acoustic sensor device 1104b, and the third acoustic sensor device 1104c and the ambient environment. The acoustic system 1100 may also include a first sound port 1116-1, a second sound port 1116-2, a third sound port 1116-3, and a fourth sound port 1116-4. The fourth sound port 1116-4 may be a shared sound port that may expose, to the ambient environment. the respective acoustic channels configured to provide couplings between first sound ports of the first acoustic sensor device 1104a, the second acoustic sensor device 1104b, and the third acoustic sensor device 1104c and the ambient environment. The first sound port 1116-1, the second sound port 1116-2, and the third sound port 1116-3 may be unshared sound ports that may expose, to the ambient environment, respective acoustic channels configured to provide couplings between second sound ports of the first acoustic sensor device 1104a, the second acoustic sensor device 1104b, and the third acoustic sensor device 1104c and the ambient environment.

The acoustic system 1100 also include a fourth acoustic sensor device 1104d, in the illustrated example. The fourth acoustic sensor device 1104d may comprise an omnidirectional acoustic sensor device, such as an omnidirectional microphone. The fourth acoustic sensor device 1104d may correspond to the acoustic sensor device 300 of FIG. 3, for example. In this example, the acoustic system 1100 may comprise an “XYZ +omnidirectional” configuration. In another example, the acoustic system 1100 may omit the fourth acoustic sensor device 1104d. The acoustic system 1100 may further include an additional acoustic channel configured provide a coupling between a single sound port of the fourth acoustic sensor device 1104d and the ambient environment. A portion of the additional acoustic channel may be included in the shared channel portion 1118. Thus, the fourth sound port 1116-4 may further expose the additional acoustic channel to the ambient environment. The fourth sound port 1116-4 may thus be shared between the first acoustic sensor device 1104a, the second acoustic sensor device 1104b, the third acoustic sensor device 1104c, and the fourth acoustic sensor device 1104d. Accordingly, because the acoustic system 1100 includes a shared channel portion and a shared sound port, the first acoustic sensor device 1104a, the second acoustic sensor device 1104b, the third acoustic sensor device 1104c, and the fourth acoustic sensor device 1104d may be integrated into an end-product device with a fewer number of sound ports provided in the end-product device as compared to a system in which no sharing of acoustic channels and no sharing of sound ports is utilized. For example, the first acoustic sensor device 1104a, the second acoustic sensor device 1104b, the third acoustic sensor device 1104c, and the fourth acoustic sensor device 1104d may be integrated into an end-product device with only four sound ports provided in the end-product device as compared to seven sound ports that would be needed in a system in which no sharing of acoustic channels and no sharing of sound ports is utilized.

Described above are a number of examples of acoustic systems that includes multiple acoustic sensor devices, such as multiple microphones, that share acoustic channels and/or acoustic ports. Because an acoustic system may include shared acoustic channels and, in some examples, shared sound ports, the multiple acoustic sensor devices may be integrated together with a reduced total physical space or footprint and/or may be integrated into an end-product device with a reduced total number of sound ports. The reduction of the total number of sound ports in the end-product device may make the system more attractive for use in various end-product devices and may least to a reduction in manufacturing cost of the end-product devices, in at least some examples.

In accordance with an aspect, an acoustic system includes a plurality of acoustic sensor devices, including at least a first acoustic sensor device and a second acoustic sensor device. The acoustic system also includes a plurality of acoustic channels, including at least a first acoustic channel configured to provide a first coupling, the first coupling being between the first acoustic sensor device and an ambient medium, and a second acoustic channel configured to provide a second coupling, the second coupling being between the second acoustic sensor device and the ambient medium. The first acoustic channel and the second acoustic channel may include a shared channel portion that includes at least a portion of the first acoustic channel that is common with at least a portion of the second acoustic channel.

In connection with any one of the aforementioned aspects, the acoustic system may alternatively or additionally include or involve any suitable combination of one or more of the following aspects or features. The acoustic system may further include a shared sound port coupled, via the shared channel portion, to the first acoustic channel and the second acoustic channel. The first acoustic sensor device and the second acoustic sensor device are arranged on the acoustic system to have directions of sensitivity that are orthogonal with respect to each other. The acoustic system may further include a third acoustic sensor device and a third acoustic channel configured to provide a third coupling, the third coupling being between the third acoustic sensor device and the ambient medium. At least a portion of the third acoustic channel is in common with respective one or more portions of one or both of the first acoustic channel and the second acoustic channel. The shared channel portion includes the at least the portion of the first acoustic channel, the at least the portion of the second acoustic channel, and the at least the portion of the third acoustic channel. The acoustic system may further include a shared sound port coupled, via the shared channel portion, to the first acoustic channel, the second acoustic channel, and the third acoustic channel. The acoustic system may further include a plurality of shared sound ports, including at least i) a first shared sound port coupled to the first acoustic channel and the second acoustic channel and ii) a second shared port coupled to the third acoustic channel and one of the first acoustic channel and the second acoustic channel. Each of the first acoustic channel and the second acoustic channel may comprise a straight shaped channel. At least one the first acoustic channel and the second acoustic channel may comprise a non-straight shaped channel. The non-straight shaped channel may include one or more of a V-shaped channel, a U-shaped channel, or an L-shaped channel. The plurality of acoustic sensor devices includes a plurality of directional microphones. The plurality of acoustic sensor devices includes at least one directional acoustic sensor device and at least one ominidirectional microphone.

The plurality of acoustic sensor devices includes at least one microelectromechanical system (MEMS) microphone. The plurality of acoustic sensor devices includes a plurality of microelectromechanical system (MEMS) microphones.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. An acoustic system, comprising:
a plurality of acoustic sensor devices, including at least a first acoustic sensor device and a second acoustic sensor device; and
a plurality of acoustic channels, including at least:
a first acoustic channel configured to provide a first coupling, the first coupling being between the first acoustic sensor device and an ambient medium, and
a second acoustic channel configured to provide a second coupling, the second coupling being between the second acoustic sensor device and the ambient medium;
wherein the first acoustic channel and the second acoustic channel include a shared channel portion, the shared channel portion including at least a portion of the first acoustic channel that is common with at least a portion of the second acoustic channel.

2. The acoustic system of claim 1, further comprising a shared sound port coupled, via the shared channel portion, to the first acoustic channel and the second acoustic channel.

3. The acoustic system of claim 1, wherein the first acoustic sensor device and the second acoustic sensor device are arranged on the acoustic system to have directions of sensitivity that are orthogonal with respect to each other.

4. The acoustic system of claim 1, further comprising:
a third acoustic sensor device; and
a third acoustic channel configured to provide a third coupling, the third coupling being between the third acoustic sensor device and the ambient medium;
wherein at least a portion of the third acoustic channel is in common with respective one or more portions of one or both of the first acoustic channel and the second acoustic channel.

5. The acoustic system of claim 4, wherein the shared channel portion includes the at least the portion of the first acoustic channel, the at least the portion of the second acoustic channel, and the at least the portion of the third acoustic channel.

6. The acoustic system of claim 4, further comprising a shared sound port coupled, via the shared channel portion, to the first acoustic channel, the second acoustic channel, and the third acoustic channel.

7. The acoustic system of claim 4, further comprising a plurality of shared sound ports, including at least i) a first shared sound port coupled to the first acoustic channel and the second acoustic channel and ii) a second shared port coupled to the third acoustic channel and one of the first acoustic channel and the second acoustic channel.

8. The acoustic system of claim 1, wherein each of the first acoustic channel and the second acoustic channel comprises a straight shaped channel.

9. The acoustic system of claim 1, wherein at least one the first acoustic channel and the second acoustic channel comprises a non-straight shaped channel.

10. The acoustic system of claim 9, wherein the non-straight shaped channel is one of a V-shaped channel, a U-shaped channel, and an L-shaped channel.

11. The acoustic system of claim 1, wherein the plurality of acoustic sensor devices includes a plurality of directional microphones.

12. The acoustic system of claim 1, wherein the plurality of acoustic sensor devices includes at least one directional acoustic sensor device and at least one ominidirectional microphone.

13. The acoustic system of claim 1, wherein the plurality of acoustic sensor devices includes at least one microelectromechanical system (MEMS) microphone.

14. The acoustic system of claim 1, wherein the plurality of acoustic sensor devices includes a plurality of microelectromechanical system (MEMS) microphones.
